(19) United States
(12) Patent Application Publication
(10) Pub. No.: US 2021/0245992 A1
(43) Pub. Date: Aug. 12, 2021

(54) METHOD AND SYSTEM FOR CONTROLLING ONE OR MORE ELEVATOR BY ONE OR MORE COMPUTING DEVICE

(71) Applicants: Esha Garg, Houston, TX (US); Veer Garg, Houston, TX (US)

(72) Inventors: Esha Garg, Houston, TX (US); Veer Garg, Houston, TX (US)

(21) Appl. No.: 17/243,733

(22) Filed: Apr. 29, 2021

Related U.S. Application Data
(60) Provisional application No. 63/017,017, filed on Apr. 29, 2020.

(51) Int. Cl. B66B 1/34; B66B 1/28

(52) U.S. Cl. CPC B66B 1/3461; G06F 3/14; B66B 1/28

(57) ABSTRACT

One or more techniques for remotely operating one or more elevators by one or more computing devices are disclosed. A control board is communicatively coupled to the elevator and one or more computing devices connected with the control board using one or more communication means. The computing device comprises a memory, and a processor coupled with the memory and configured to establish a connection with the control board using the one or more communication means, receive one or more information from the control board, wherein the one or more information comprises at least one of location of the elevator, a number of elevators, a number of buttons present in each elevator and a layout of the buttons present inside the elevator, and wherein buttons present inside the elevator control one or more operations of the elevator, remotely control the elevator based on the received information.

### CROSS-REFERENCE TO RELATED APPLICATIONS

This application claims the benefit of U.S. Provisional Application No. 63/017,017, filed on 29 Apr. 2020 and titled “CONTACTLESS EQUIPMENT CONTROL SYSTEM AND METHOD OF USE”. The entire disclosure of the above application is hereby incorporated herein by reference.

### TECHNICAL FIELD

The present invention relates generally to a method and system for operating one or more elevators in a building, and more particularly, to a method and system for remotely operating one or more elevators using one or more computing devices.

### BACKGROUND

Elevator transportation is old and well known in the art. An elevator, or lift, is a generally a vertical transportation machine that moves people and/or freight from one floor or level to another floor or level of a building and/or other structure. Generally, an elevator is powered by an electric motor that moves cables along with counterweights such that the elevator can move vertically. Some elevators move sideways, but generally, most elevators move vertically or up and down.

Elevators typically operate in the same familiar fashion, via general controls. Nearly every elevator has same familiar controls a modern passenger will use to operate an elevator. Outside an elevator, a user will find a simple up and down button. The bottom floor will only have an up button and the top floor will only have a down button while the floors in between will have both an up and a down button. These buttons send a signal to activate the motor to send the elevator to appropriate settings. These settings correspond with the floor where the elevator was called and the door will open. If the elevator is already present at that floor, the door will open when activated and the passenger may get inside the elevator.

The interior of the elevator is generally box-like with various spacing and sizes to accommodate various numbers of people/passenger or freight. In some variations, elevators also include guardrails or seats. The elevators also include overload sensors, warning signals, buzzers, alarms, full car indicator, and the like. Some elevators are manually controlled while most include a control panel with various buttons.

Control panels, included in almost every elevator, provide various purposes and functionality. The main function of which is to aid a user in choosing a floor or next destination. Floors are chosen by a user via pushing one of a plurality of call buttons. These call buttons correspond to a floor in the building. Some of the floors have special designations such as a lobby, parking floor, or garage. Additionally, some security measures can be implemented in which a key is required to access certain floors through engaging certain buttons. These security measures activate the elevator to move to the floor only when a proper key or magnetic scan can be used.

While many users/passengers travel in the elevator, the buttons are pressed by each of the passenger/user to select a particular floor/destination. Disease, viruses, bacteria, and the like spread through common touches of surfaces and are commonly carried by fluids. In this way, elevators and more principally call buttons can transfer disease, viruses, bacteria, and cause other contaminations amongst users of an elevator. In this way, call buttons can cause a spread of disease among other functionality. Additionally, elevator buttons and the invitation of third-party guests to a secured floor can cause complex issues for residential and business buildings, amongst other types of structures.

In additional circumstances, elevator call buttons and elevators can cause security problems for users who are not third parties. For example, many buildings require secured floors for employees. In this way, access to certain floors is limited to those with a proper security badge or magnetic scan card or another scan card. These security cards are often forgotten or can be lost, jeopardizing security of a facility.

Thus, it is a primary object of this disclosure to provide an elevator control system and method of use that provides a user a means of communicating with an elevator and controlling an elevator without touching the call buttons in the elevator or without requiring security cards. Therefore, it is a primary object of this disclosure to provide a means of operating an elevator that is safer and more secure.

### SUMMARY

It will be understood that this disclosure in not limited to the particular systems, and methodologies described, as there can be multiple possible embodiments of the present disclosure which are not expressly illustrated in the present disclosure. It is also to be understood that the terminology used in the description is for the purpose of describing the particular versions or embodiments only, and is not intended to limit the scope of the present disclosure.

In one non-limiting embodiment, a system for controlling one or more elevators by one or more computing devices is provided. The system comprises a control board is communicatively coupled to the elevator and the one or more computing devices connected with the control board using one or more communication means. The computing device comprises a memory, and a processor coupled with the memory and configured to establish a connection with the control board using the one or more communication means, receive one or more information from the control board, wherein the one or more information comprises at least one of location of the elevator, a number of elevators, a number of buttons present in each elevator and a layout of the buttons present inside the elevator, and wherein buttons present inside the elevator control one or more operations of the elevator, remotely control the elevator based on the received information.

In another non-limiting embodiment, a method for remotely controlling one or more elevators by one or more computing devices is provided. The method comprises establishing a connection with a control board, wherein the control board is communicatively coupled to the elevator, and wherein the one or more computing devices is connected with the control board via a wireless network, receiving one or more information from the control board, wherein the one or more information comprises at least one of location of the elevator, a number of elevators, a number of buttons present in each elevator and the elevator layout, and wherein buttons control one or more operations of the elevator and remotely controlling the elevator based on the received information.

These and other features and advantages of the present invention will become apparent from the detailed description below, in light of the accompanying drawings.

### BRIEF DESCRIPTION OF THE DRAWINGS

FIG. 1 illustrates a block diagram of a system for remotely operating one or more elevators using one or more computing devices, according to an exemplary embodiment of the present invention;

FIG. 2 illustrates a block diagram of control board, according to an exemplary embodiment of the present invention;

FIG. 3 shows various pages of an application, according to an exemplary embodiment of the present invention;

FIG. 4 illustrates a page from the application, according to an exemplary embodiment of the present invention;

FIG. 5 illustrates a page from the application, according to a yet another exemplary embodiment of the present invention;

FIG. 6 illustrates a page from the application, according to yet another exemplary embodiment of the present invention; and

FIG. 7 illustrates a page from the application, according to yet another exemplary embodiment of the present invention.

FIG. 8 illustrates a page from the application, according to yet another exemplary embodiment of the present invention.

FIG. 9 illustrates a page from the application, according to yet another exemplary embodiment of the present invention.

FIG. 10 illustrates a flow diagram of a method for operating one or more elevators from one or more computing devices, according to yet another exemplary embodiment of the present invention.

### DETAILED DESCRIPTION

As used in the specification, the singular forms “a”, “an” and “the” may also include plural references. For example, the term “an article” may include a plurality of articles. Those with ordinary skill in the art will appreciate that the elements in the figures are illustrated for simplicity and clarity and are not necessarily drawn to scale. There may be additional components or processes described in the foregoing application that are not depicted on the described drawings. In the event such a component or process is described, but not depicted in a drawing, the absence of such component and process from the drawings should not be considered as an omission of such design from the specification.

Before describing the present invention in detail, it should be observed that the present invention utilizes a combination of components or processes, which constitutes a method and system for remotely operating one or more elevators using one or more computing devices. Accordingly, the components or processes have been represented, showing only specific details that are pertinent for an understanding of the present invention so as not to obscure the disclosure with details that will be readily apparent to those with ordinary skill in the art having the benefit of the description herein. As required, detailed embodiments of the present invention are disclosed herein; however, it is to be understood that the disclosed embodiments are merely exemplary of the invention, which can be embodied in various forms. Therefore, specific component level details and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

References to “one embodiment”, “an embodiment”, “another embodiment”, “one example”, “an example”, “another example”, “yet another example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment. The words “comprising”, “having”, “containing”, and “including”, and other forms thereof, are intended to be equivalent in meaning and be open ended in that an item or items following any one of these words is not meant to be an exhaustive listing of such item or items or meant to be limited to only the listed item or items.

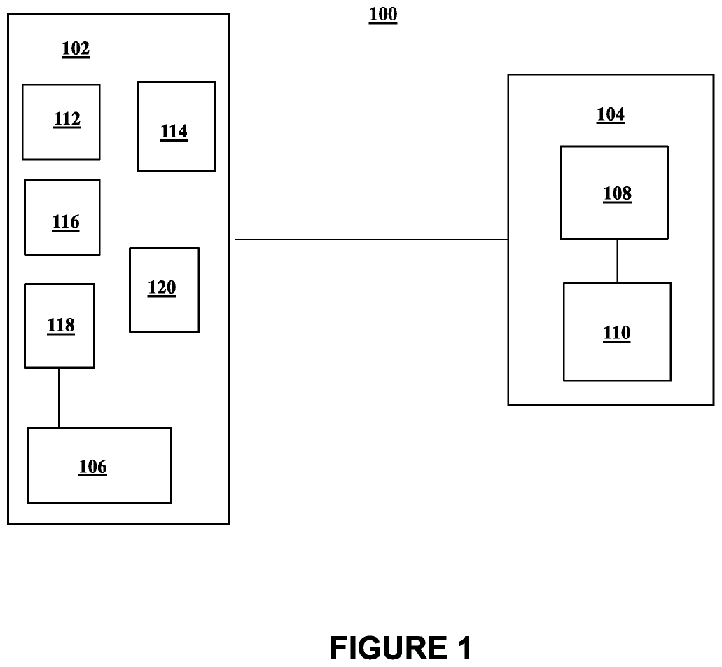

The method and system for remotely operating one or more elevators using one or more computing devices will now be described with reference to the accompanying drawings, particularly FIGS. 1-10.

Referring to FIG. 1, a block diagram of a system 100 for operating one or more elevators 102 by one or more computing devices 104 is shown. The system 100 comprises the one or more elevators 102, one or more computing devices 104 and a control board 106. Although, the present invention involves one or more elevators 102 and one or more computing devices 104, the description has been explained considering one elevator and one computing device in order to keep the description concise and simple.

The computing devices 104 may include a smartphone, a laptop, a computer, a tablet, etc. The computing devices 104 comprises a memory 108 and a processor 110 coupled to the memory 108. The computing devices 104 may also include a transceiver for sending/receiving data. Further, the computing devices 104 may also include functions which may enable the computing devices 104 to have wireless communication with the elevator 102. The wireless communication includes a short-range communication and/or long-range communications. Examples of short-range communications may include proximity-based communications such as Bluetooth, near field communication (NFC). Further, examples of long-range communications may include communication over cellular network or Wi-Fi networks. The examples mentioned here for short-range communication and long-range communication are only for exemplary purposes and may not be limited to the one mentioned here.

The computing device 104 communicates with the elevator for operating the elevator 102 using the above defined wireless communication techniques. As explained above, the operations of elevator 102 may include moving up/down to the destination floors when a button is pressed. The button may be pressed to either call the elevator 102 to a particular floor or to make the elevator reach the particular destination floor number corresponding to which the button is pressed.

The elevator 102 may include an elevator body 112, a motor 114, a transport mechanism 116, a controller 118 and a plurality of buttons 120, among other components.

The elevator body 112 may be in a form of a closed container. The container may be formed of any suitable size, shape, and design and may be configured as the main structure of the elevator 102. The body 112 may be the container in which a user or plurality of users enters to be transported from one floor to another. Some containers may be square shaped boxes. This is the most common type of person transport. Other shapes of the body 112 may include a flat surface with guardrails.

The motor 114 may be formed of any suitable size, shape, and design and may be configured to power the elevator 102, causing movement vertically. Many motors may be electrically operated and may use a cable with counterweights as a transport mechanism 116, other motor types are hereby contemplated for use.

The motor 114 may be operated by the controller 118. The controller 118 may be formed of any suitable size, shape, and design and may be configured and programmed to cause the motor 114 to operate when any one of the plurality of controls (or “plurality of buttons”) are engaged. In this way, the controller 118 is programmed such that when the button for floor fourteen is pressed, the controller 118 will activate the motor 114 in a way which causes the elevator body 112 to move the elevator 102 to floor fourteen.

The elevator 102 further includes the plurality of buttons 120 (or “plurality of controls”). The plurality of buttons 120 may be formed of any suitable size, shape, design, and vary from building to building and elevator design and may be formed to provide a user a means of interacting with and controlling an elevator or a plurality of elevators, especially those situated in a bay of elevators.

The plurality of buttons 120 may include up and down buttons which may exist on a plurality of floors and may be available for a user to call an elevator to the floor the user is currently at. In addition to being located on each floor, the interior of the elevator may also house the plurality of buttons 120 including but not limited to a button identifying each floor, and may also include a “call” button, a “ground” button, a “parking” button (for various parking garage levels”), a “lobby” button, an “open door” button, a “close door” button, and other buttons, controls, and features.

The elevator 102 may also include a memory (not shown). The memory may store various elevator control programs which may be helpful in operating the elevator 102.

To allow the passengers/users to operate the elevator remotely, the control board 106 in the form of a bridge between the elevator 102 and the users is provided. The control board 106 may be formed of any suitable size, shape, and design and may be configured to attach to the existing elevator controllers 118. Furthermore, control board 106 may be configured to adapt to an existing elevator controller 118 such that the control board 106 may cause the actions of the controller 118 to be triggered. The control board 106 may also receive actions for the controller 118 to execute. In this way, and without limitation, the control board 106 acts as a relay which communicates a signal to the elevator controller 118. In this way, the control board 106 can communicate with the existing elevator controller 118 and a user/passenger.

In one embodiment, the control board 106 is configured to create a bridge from the controller 118 to the application running on the computing device 104. The application may then control the controller 118 through the bridge. Furthermore, the control board 106 may be configured to allow the control of any number of buttons present in the elevator 102 such that the plurality of buttons 120 can be adapted to the control board 106 and controlled.

In the arrangement shown, as one example, control board 106 may include a retrofit system. Retrofit system may be formed of any suitable size, shape, and design and may be configured to adapt the control board 106 to existing elevator systems. In this way, the control board 106 can be installed onto old or pre-existing elevator systems so that the old or pre-existing system can be controlled by control board 106.

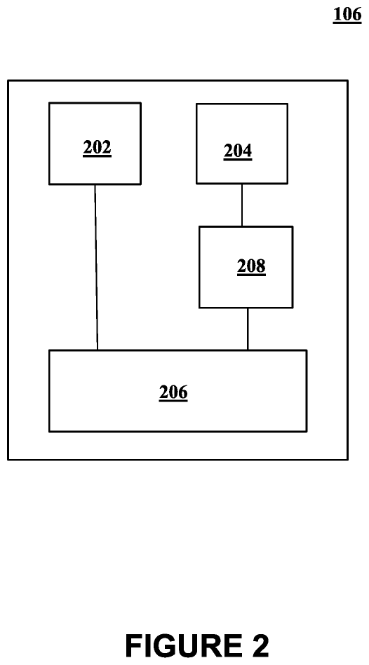

A block diagram of the control board 106 is shown in FIG. 2. As shown in FIG. 2, the control board 106 includes a memory 202, a transceiver 204 and a processor 206 coupled to the memory 202 and the transceiver 204. The control board 106 also include means 208 for communicating with the computing device 104. The means 208 may include one or more means for establishing wireless communication with the computing device 104 and/or a server. The wireless communication may include a Bluetooth, a near-field communication connection, a wi-fi connection, and a cellular communication device, among other components, features, or functions.

The control board 106 is integrated with a control panel of the elevator 102. For example, the control board 106 may comprise of connectors and hook to be able to connect to the control panel of the elevator 102. The control board 106 is configured to establish communication with the computing device 104. The processor 110 of the computing device 104 is configured to establish the wireless communication with the control board 106. The communication may include communication using Bluetooth communication, Wi-Fi communication, near field communication (NFC), cellular communication, etc. After establishing the communication with the control board 106, the processor 110 is configured to receive one or more information from the control board 106. The one or more information comprises number of the one or more elevators, a number of buttons present in each elevator and a layout of the buttons present inside the one or more elevators elevator, and wherein buttons present inside the one or more elevators elevator control one or more operations of the elevator. Each of the options present inside the elevator is explained below. The elevator 102 is thus remotely monitored based on the received one or more information. The processor 110 is configured to display the layout of the buttons on the computing device 104. In one embodiment, the user selects the communication means, by which way the user wants to establish communication with the control board 106, from the application.

In one embodiment, the communication means are selected based on proximity of the user with the elevator. For example, if the user is present inside the elevator, the user may be provided to select from short range communication. That is, if the user is present inside the elevator, the user may be provided with option to select either Near field communication (NFC) or Bluetooth to connect the computing device 104 with the control board 106. In another example, if the user is not present inside the elevator 102, the user may be provided with option to connect to the control board 106 using the cellular network available on the computing device 104. In one more embodiment, if the building where the elevator is present comprises a Wi-Fi network, the user may connect to the computing device 104 from anywhere in the building when the computing device 104 is connected to the Wi-Fi network.

In one embodiment, the computing device 104 includes a gyroscope. The gyroscope is used to detect a direction in which the computing device 104 is pointing. The processor 110 is configured to identify a direction of travel of a user based on the detected direction in which the computing device is pointing, transmit the identified direction of travel of the user to the control board, wherein the control board is configured to configure the direction of the elevator based on the received direction of travel of the user. For example, if it is detected by the gyroscope that the computing device 104 is pointing upwards direction, the upward direction is transmitted to the control board 106 (after a connection has been established between the computing device and the control board). The control board 106 after knowing that the user wants to move towards upwards direction may configure the direction of the elevator in upwards direction. This also ensures touchless usage of the elevator 102 by the user.

With the present invention, the user/passenger is able to use the elevator 102 without the need of touching the buttons 120 of the elevator. To use the elevator 102, the user/passenger may use an application running on the computing device 104. The configuration of the application happens in two views—a first view and a second view. In the first view, a display page at the time of establishing a communication between the control board 106 and the application is shown. While in the second view, a display page is shown to the user when the user uses the application for controlling the operation of the elevator 102.

The first view of the application and the registration of the control board 106 with the application is first explained followed by the second view of the application.

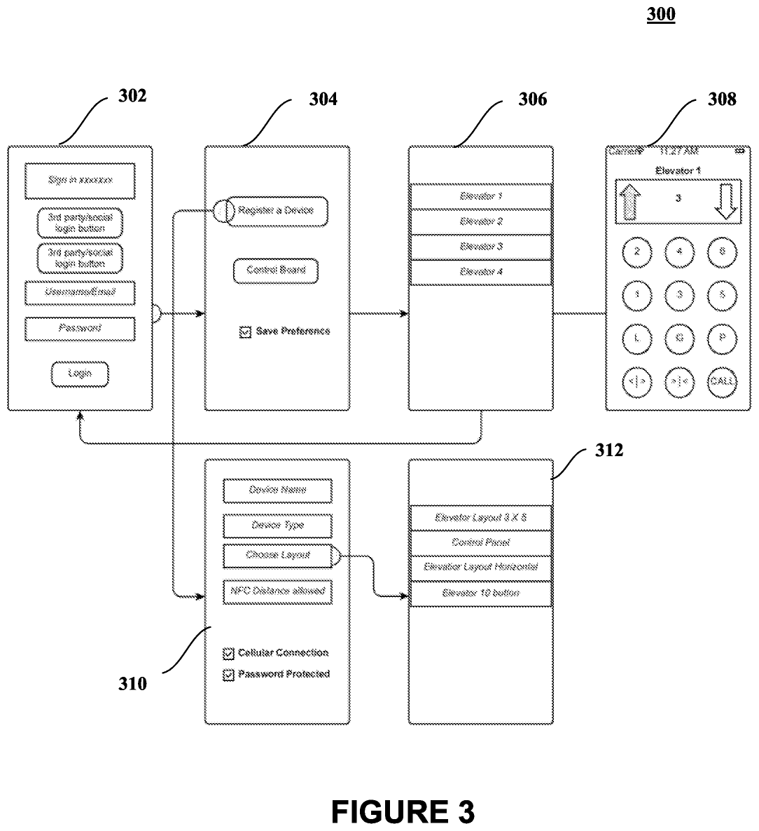

An overview of various pages of the application 300 running on the computing device 104 is shown in FIG. 3. In brief, a page 302 shows various options to the user for registering with the application. In one embodiment, the options may be used for authenticating the user with the application. Once the user is registered/authenticated in the page 302, the next page 304 is displayed which provides the user with option to register the device for controlling the operations of the elevator 102. This option may be provided to an end user who will use the elevator 102 for travelling to various floors. Further, the page 304 may include an option for operating/configuring the control board 106. Once an option among these two is selected on the page 304, a page 306 is displayed to the user. The page 306 displays a list of available elevators to the user. One of the elevators from the list of elevators may be selected based on the selected option. When an elevator is selected, a plurality of buttons for operating the elevator is shown to the user on a page 308. In one embodiment, from the page 304, the user may also be presented with a page 310 and a page 312. The pages 310 and 312 lists down various configuration operations for elevator 102. (as will be explained below).

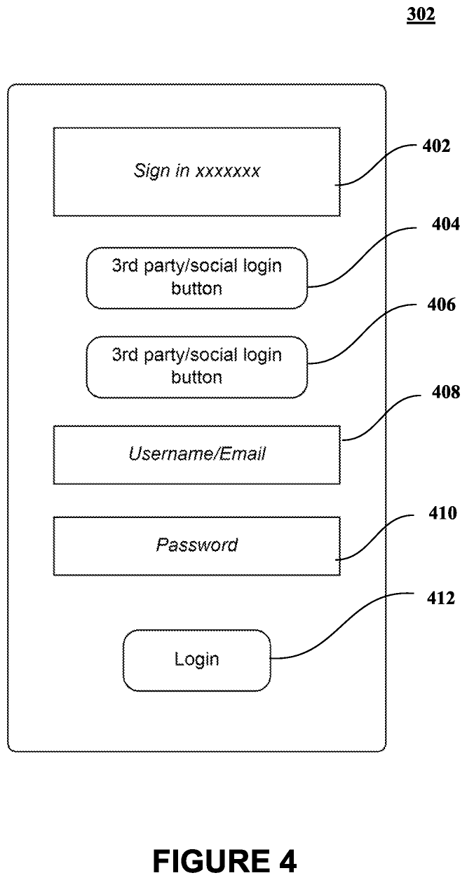

Detailed explanations of each of the pages are now explained below with reference to FIGS. 4-9.

Referring to FIG. 4, the page 302 of the application 300 is shown. As shown in FIG. 4, the user may be presented with various options 402, 404, 406, 408, 410 and 412. In one embodiment, the user may be presented with the page 302 when the user launches the application 300 for the first time.

All the options shown in FIG. 4 allow the user to sign in the application 300. With option 402, the user may decide by what name the user would like to be called in the application. Thus, option 402 provides for an option to sign in as “name” of the user. The user may also want to sign in using the social media details. This option is presented to the user as option 404, where the user may use account details of his/her social media account to register with the application 300. Although, options 404 and 406 appears to be same, they may be used for different social media platforms. For example, option 404 may be used to login using the social media platform Facebook while the option 406 may be used to login using the social media platform Instagram. In one embodiment, only one option from 404 or 406 may be presented and other may be completely omitted.

If the user does not want to login using the social media account details, the user may create an account on the application with options 408 and 410. With options 408 and 410, the user may choose a username and set a password which the user may want to use to login in the application 300. The account details, such as the username and the password, may be stored on a cloud server. When the user registers on the application 300, a user profile may be created. The user profile may contain the details of the elevator and preferred way of communicating with the registered devices, as explained below. The user profile may also be associated with an elevator from the one or more elevators and operate the elevator based on the information present in the user profile. For example, out of the 4 elevators present in a building, the elevator number 2 may be the only elevator which may stop at the floor where the user resides. Thus, in the user profile, the elevator number 2 may be pre-stored. In one embodiment, the user profile comprises information about a verified geographic location of the user and a contact address of the user.

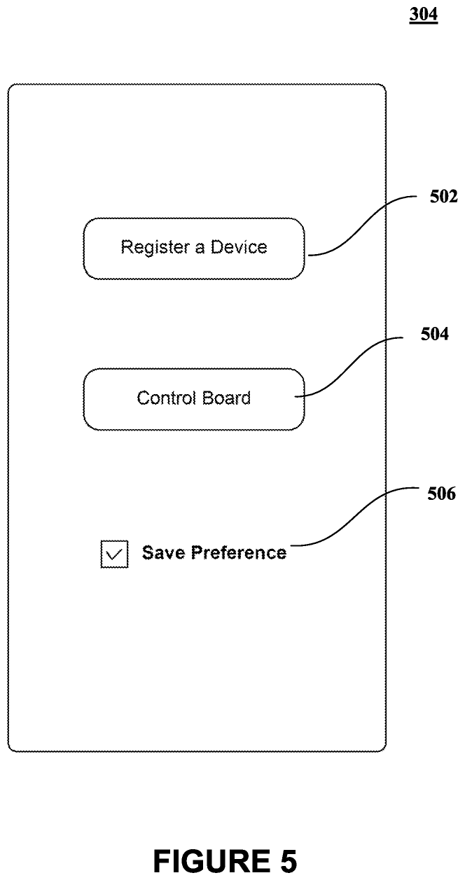

Referring to FIG. 5 now, options may be presented to the user to either register a device (option 502) or to access and set up the control board 106 (option 504). When the user decides to select the option 502, the user may be allowed to either register the elevator on the application or to access the control board 106 present inside the elevator. The option 504 may be selected by the user who wants to perform backend processes. Thus, option 504 may not be displayed to the user who is using the elevator 102 for moving between the floors in a building.

Thus, the option 504 may allow the user to connect to the control board 106 which is connected to the controller 118. In other words, the option 504 may provide an interaction between a user and the control board 106 so that the user can configure the control board 106. Said yet another way, the option 504 may be configured to provide the user a means of setting up the control board 106 such that the application 300 will virtually represent the same number of buttons and controls, to a user, as the real-life elevator 102 provides.

A user may also be given an option 506 to save preference i.e. either to proceed with option 502 or option 504 the next time user launches the application 300.

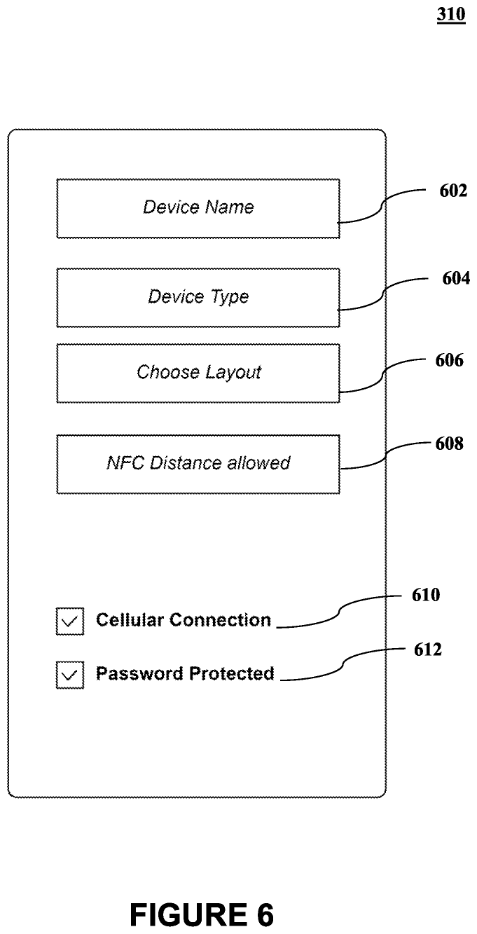

When the option 502 is selected, the user may be presented with options to register an elevator. The page 310 is displayed to the user when the option 502 is selected. Thus, referring to FIG. 6, a page 310 in the application 300 is shown to the user when the option 502 is selected by the user. The page 310 shows various options for registering the device, i.e., elevator with the application 300. The registration may include option 602 for providing a name to the elevator. Similarly, option 604 provides an option to provide/select a type of elevator. By way of example, if the elevator is used for residents, the type of elevator may be “resident elevator”. Similarly, if the elevator is used for guests, the type of elevator may be “guest's elevator”.

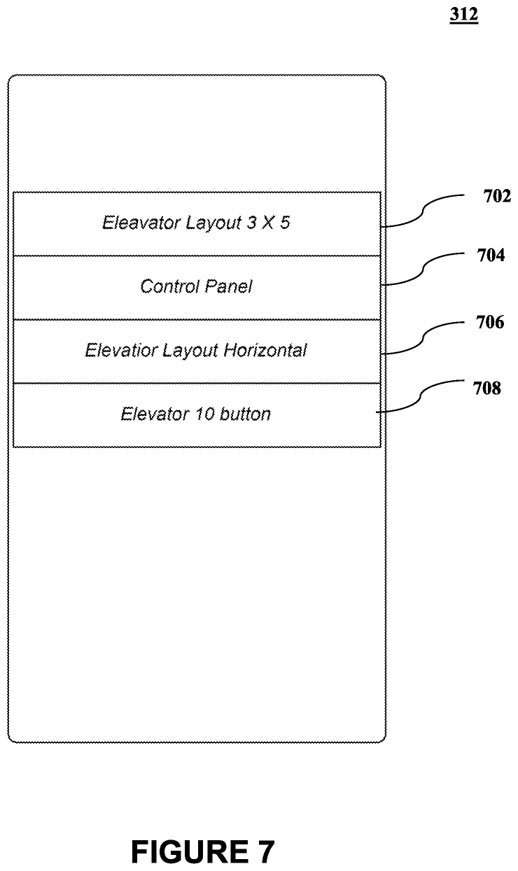

Other options may include option 606 for choosing a layout for the elevator. The layout has been explained further in FIG. 7. In one embodiment, the layout is customizable.

Yet another option may include option 608. The option 608 may provide for establishing a wireless communication of the application 300 with the elevator 102 using near field communication (NFC). The option 608 allows the user to either enable or disable this option. In one embodiment, the user can select the communication means the user wants to use for communicating with the control board. For example, the user may use short range communication or long-range communication as defined above.

In one embodiment, the page 600 may also include options 610 and 612. The option 610 may include option for establishing a wireless communication of the application 300 with the elevator 102 using cellular connection. The option 610 allows the user to either enable or disable the option. Further, the option 612 allows the user to choose whether the elevator will require a passcode and/or password to control the elevator. In one embodiment, the password and/or passcode may be displayed on a physical sign in the elevator so that a user must be on the elevator in order to see the password and be able to select a floor destination. The user may enable/disable the option 612. Requiring a usage of passcode will also restrict the user to control the operation of the elevator only when the user is present inside the elevator 102.

Upon selecting the option 606, the page 312 may appear on the application 300. The page 312 has been shown on FIG. 7. As shown in FIG. 7, the page 312 may contain options 702, 704, 706 and 710. These options may be used to further customise the display of the controls used in controlling the elevators.

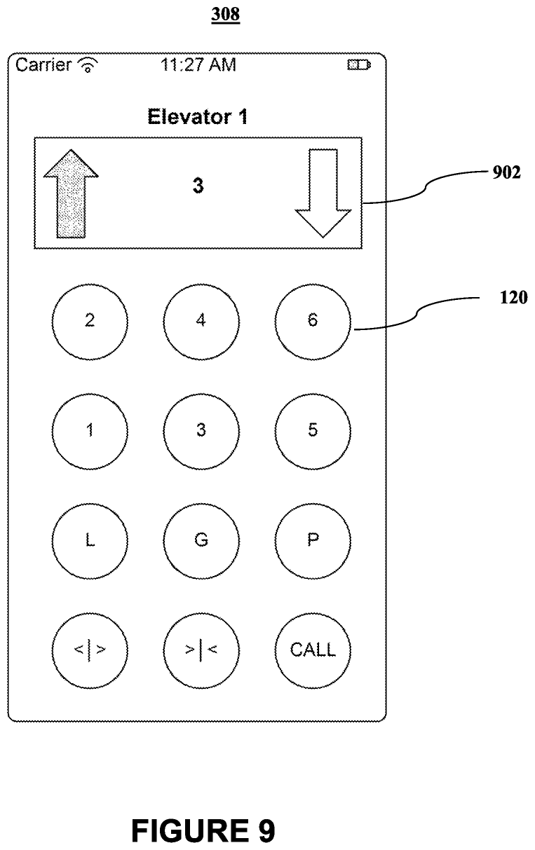

The option 702 to select layout may include selecting layout of the elevator. The layout may include style of displaying, for example, list of elevators to the user. The option 704 may include option to select a control panel of the elevator 102. The control panel may be used to access internal programs of the elevator 102. This option may be used by an administrator or a technician/service engineer for accessing the programs of the elevator 102. This may allow a user to make changes in configuration/settings of the elevator 102. Similarly, the option 706 may include a style of displaying elevator in a horizontal way. Further, the option 708 may include a way to access elevator button. The user may select this option to display the plurality of buttons 120 as shown in FIG. 9. In one embodiment, the layout of the elevator can be customized by the user.

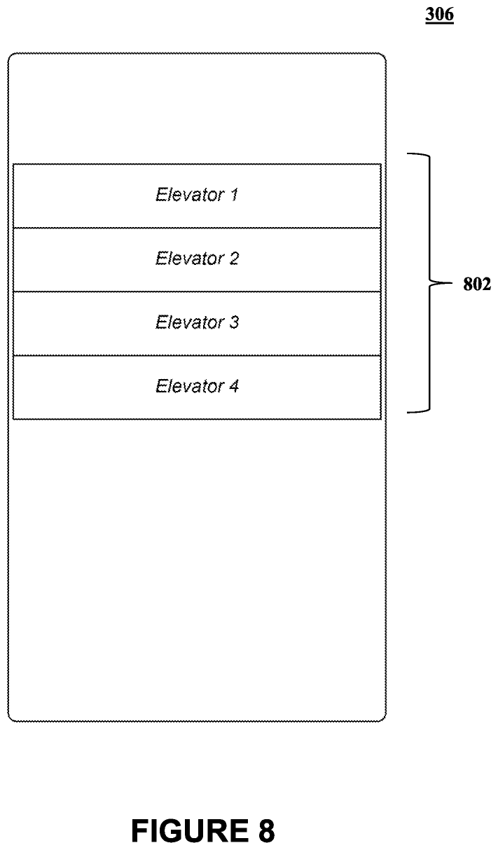

When registration on the application 300 is finished, upon launching the application 300, the user may be presented with a page 306 as shown in FIG. 8. The page 306 shows a list of elevators with names elevator 1, elevator 2, elevator 3 and elevator 4. An option 802 may be provided to the user to select one of the elevators from the list of elevators shown to the user. The name of the elevators is selected by the user in the FIG. 6 under option 602. When the user selects any of the elevator from the list of elevators displayed in FIG. 8, the user is presented, on the computing device 104, with the plurality of buttons 120 present in the selected elevator (as shown in FIG. 9). FIG. 9 shows the page 308 for selecting the plurality of buttons 120. The plurality of buttons 120 may be used for selecting the floor number and a button to call the elevator. Further, as shown in FIG. 9, a display 902 on the computing device 104 shows a floor number 3 which may be selected by the user and an arrow showing elevator moving upwards. In one embodiment, the user may customize the number of buttons to be displayed on the page 306. For example, if the user only uses 1^{st} to 5^{th} floor only, then the user instead of viewing only the buttons 1-10 on the page 306 may only see the buttons 1^{st} to 5^{th} on the page 306.

In one embodiment, the user can choose how far a user can be from the elevator and still have the ability to control the elevator, choose whether the elevator will require a passcode and/or password to control the elevator, customize the passcode or password and choose whether the passcode changes at a regular timed interval, choose whether a user must be inside the elevator to control the elevator and choose whether a scan will be used to control the elevator. The scan may be, for example, scanning a QR code.

This enables the user to operate the elevator using the computing device without touching the buttons present in the elevator.

The present invention is now explained with an example. A user registers on an application running on the computing device. The registration process is the process of connecting the system 100 to an elevator 102. The process includes hardwiring the control board to the elevator system whether locally at the elevator and/or in a control room, or the like.

The next phase of the registration process includes setting up the control board 106 through the mobile application and/or through a computing device (laptop or computer). This includes setting up the elevator location, the number of elevators, the number of buttons each elevator has, the elevator layout, and more. This also includes setting up the controls of a user, what users are allowed to control the elevator, accessing elevator functions through a passcode, a password, a QR scan, and the like. This may also include setting up the elevator functionality with cloud-based services so the elevator can be controlled remotely.

Customer Usage (NFC): Once an elevator system has registered, in one example system 100 utilizes near-field communication to control the elevator. Near-field communication or “NFC” is a modern communication protocol between two electronic devices. Most modern smartphones are equipped with NFC capabilities. Through NFC, a user is able to control the elevator functionality and communicate with an elevator system using their smartphone and/or other NFC enabled device.

Customer Usage (Bluetooth): In another example, once an elevator 102 has registered, in one example system 100 utilizes bluetooth and/or bluetooth low energy, or “LE” communication to control the elevator. Bluetooth communication is a wireless personal network that provides communication protocol between two electronic devices. Most modern smartphones are equipped with bluetooth capabilities. Through bluetooth, a user is able to control the elevator functionality and communicate with an elevator system using their smartphone and/or other bluetooth enabled device.

Customer Usage (Wifi): As another example, once an elevator 102 has registered, in one example system 100 utilizes a wireless internet connection for communication to control the elevator. Once the control board 106 is connected to the wireless internet, a user is able to control the elevator functionality and communicate with an elevator system using their smartphone and/or other internet enabled device.

Customer Usage (Cellular): As another example, once an elevator 102 has registered, in one example system 100 utilizes a cellular communication connection for communication to control the elevator. Once the control board 106 is connected to the cellular network, a user is able to control the elevator functionality and communicate with an elevator system using their smartphone and/or other cellular network enabled device.

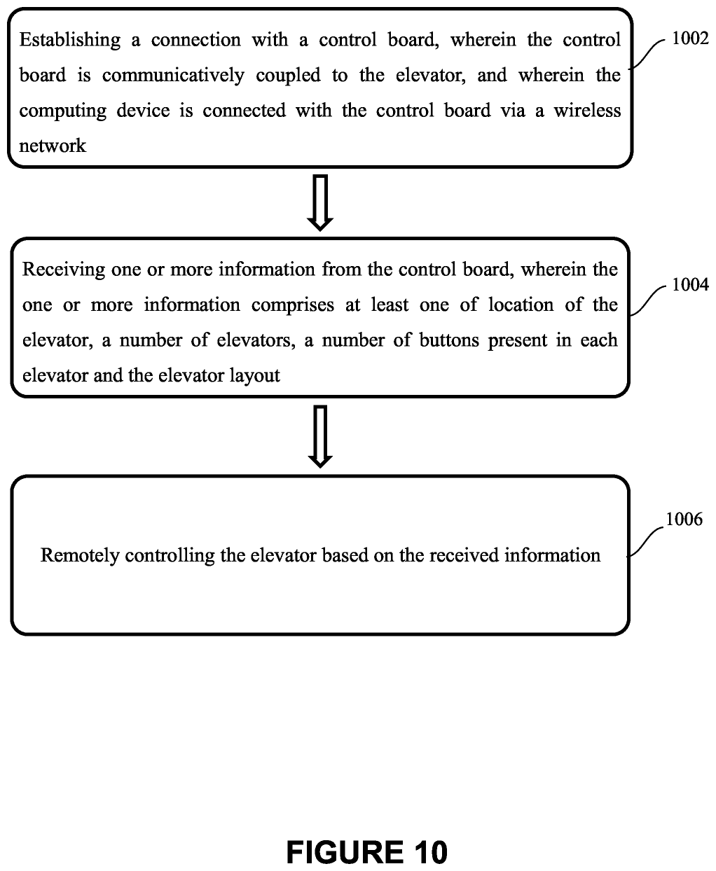

Referring to FIG. 10, a method for operating one or more elevators through one or more computing devices is shown. At step 1002, the method comprises establishing a connection with a control board, wherein the control board is communicatively coupled to the elevator, and wherein the computing device is connected with the control board via a wireless network. At step 1004, the method comprises receiving one or more information from the control board, wherein the one or more information comprises at least one of location of the elevator, a number of elevators, a number of buttons present in each elevator and the elevator layout, and wherein buttons control one or more operations of the elevator. At step 1006, the method comprises remotely controlling the elevator based on the received information.

Although the present invention has been explained considering operation of elevators, the present invention is applicable to any field where a contactless touching is required by a plurality of users. In other words, the present invention may be applied to any field for remote operations, thereby, preventing the contactless touching by the plurality of users.

The various actions, acts, blocks, steps, or the like in the flow diagram may be performed in the order presented, in a different order or simultaneously. Further, in some embodiments, some of the actions, acts, blocks, steps, or the like may be omitted, added, modified, skipped, or the like without departing from the scope of the invention.

Although particular embodiments of the invention have been described in detail for purposes of illustration, various modifications and enhancements may be made without departing from the spirit and scope of the invention.

What is claimed is:

1. A system for controlling one or more elevators by one or more computing devices, the system comprising:
a control board communicatively coupled to the one or more elevator;
the one or more computing devices connected with the control board using one or more communication means, wherein the computing device comprises:
a memory; and
a processor coupled with the memory and configured to:
establish a connection with the control board using the one or more communication means;
receive one or more information from the control board, wherein the one or more information comprises at least one of location of the one or more elevator, a number of the one or more elevators, a number of buttons present in each elevator and a layout of the buttons present inside the one or more elevator, and wherein buttons present inside the one or more elevator control one or more operations of the one or more elevator;
remotely control the one or more elevator based on the received information.

2. The system of claim 1, wherein the processor is configured to:
display a layout of the buttons on a display of the computing device, wherein the layout of the buttons is similar to the layout present on the one or more elevator;
allow a user to operate the one or more elevator based on the layout displayed on the display of the computing device.

3. The system of claim 1, wherein the control board is integrated with a control panel of the one or more elevator.

4. The system of claim 1, wherein one or more communication means comprises a near filed communication, a Bluetooth communication, a Wi-Fi communication, a cellular network.

5. The system of claim 4, wherein the one or more communication means are selected based on a proximity of a user with the elevator.

6. The system of claim 1, wherein the processor is further configured to:
generate a user profile corresponding to a user configured to operate the one or more elevator;
wherein the user profile comprises information about a verified geographic location of the user and a contact address of the user.

7. The system of claim 5, wherein the processor is configured to associate an elevator from the one or more elevator with the user profile and operate the elevator based on the information present in the user profile.

8. The system of claim 1, wherein the computing device further comprises:
a gyroscope configured to detect a direction in which the computing device is pointing;
wherein the processor is configured to:
identify a direction of travel of a user based on the detected direction in which the computing device is pointing;
transmit the identified direction of travel of the user to the control board;
wherein the control board is configured to configure the direction of the one or more elevator based on the received direction of travel of the user.

9. The system of claim 1, wherein the processor is configured to allow a user to:
decide a name to be used for the elevator,
customize a number of buttons to be displayed on a display of the computing device;
customize a layout of the buttons to be displayed on a display of the computing device,
choose the communication means for establishing the connection with the control board;
choose how far a user can be from the elevator and still have the ability to control the elevator;
choose whether the elevator will require a passcode and/or password to control the elevator,
customize the passcode or password and choose whether the passcode changes at a regular timed interval,
choose whether a user must be inside the elevator to control the elevator,
choose whether a scan will be used to control the one or more elevator.

10. A method for remotely controlling one or more elevators by a one or more computing devices, the method comprising:
establishing a connection with a control board, wherein the control board is communicatively coupled to the one or more elevator, and wherein the one or more computing devices is connected with the control board via a wireless network;
receiving one or more information from the control board, wherein the one or more information comprises at least one of location of the one or more elevator, a number of one or more elevators, a number of buttons present in each elevator and the layout of the one or more elevators, and wherein buttons control one or more operations of the one or more elevator;
remotely controlling the one or more elevator based on the received information.

11. The method of claim 10 further comprises:
displaying a layout of the buttons on a display of the computing device, wherein the layout of the buttons is similar to the layout present on the one or more elevator;
allowing a user to operate the one or more elevator based on the layout displayed on the display of the computing device.

12. The method of claim 10, wherein the control board is integrated with a control panel of the elevator.

13. The method of claim 10, wherein thee wireless network comprises a near filed communication, a Bluetooth communication, a Wi-Fi communication, a cellular network.

14. The method of claim 10 further comprises:
generating a user profile corresponding to a user configured to operate the one or more elevator;
wherein the user profile comprises information about a verified geographic location of the user, a contact address of the user.

15. The method of claim 10 further comprises associating the one or more elevator with the user profile and operating the elevator based on the information present in the user profile.

16. The method of claim 10, wherein the computing device further comprises:
a gyroscope configured to detect a direction in which the computing device is pointing;
wherein the method comprises:
identifying a direction of travel of a user based on the detected direction in which the computing device is pointing;
transmitting the identified direction of travel of the user to the control board;
wherein the control board is configured to configure the direction of the elevator based on the received direction of travel of the user.

17. The method of claim 10 further comprises:
allowing a user to:
decide a name to be used for the elevator,
customize a number of buttons to be displayed on a display of the computing device;
customize a layout of the buttons to be displayed on a display of the computing device,
choose a means for establishing a connection with the control board;
choose how far a user can be from the elevator and still have the ability to control the elevator;
choose whether the elevator will require a passcode and/or password to control the elevator,
customize the passcode or password and choose whether the passcode changes at a regular timed interval,
choose whether a user must be inside the elevator to control the elevator,
choose whether a scan will be used to control the one or more elevator.
